(19) United States
(12) Patent Application Publication
(10) Pub. No.: US 2026/0004624 A1
(43) Pub. Date: Jan. 1, 2026

(54) SYSTEM FOR WEAPON IDENTIFICATION, LOCKING AND ADMINISTRATION

(71) Applicant: Zsolt SÖRÖS, Fót (HU)

(72) Inventor: Zsolt SÖRÖS, Fót (HU)

(21) Appl. No.: 19/322,423

(22) Filed: Sep. 8, 2025

Related U.S. Application Data
(63) Continuation-in-part of application No. 18/691,292, filed on Mar. 12, 2024, now abandoned.

(30) Foreign Application Priority Data
Sep. 16, 2021 (HU) U2100167

(51) Int. Cl. G07C 9/00; A47B 81/00; G06Q 10/087

(52) U.S. Cl. CPC G07C 9/00912; A47B 81/005; G06Q 10/08772; G07C 9/00309

(57) ABSTRACT

A system for controlling issuance and return of weapons includes a plurality of weapon storage compartments each having a unique identifier, an access barrier, a lock operably associated with the access barrier, and at least one sensor configured to sense a transition of the access barrier between a locked state and an unlocked state. An access terminal configured to receive a user identifier is operably associated with the lock and creates and stores an event record of the transition between the locked state and the unlocked state of the access barrier.

### CROSS-REFERENCE TO RELATED APPLICATIONS

This application is a continuation-in-part (CIP) of U.S. patent application Ser. No. 18/691,292, filed on Mar. 12, 2024, which, in turn, is a U.S. National Stage of PCT/HU2022/000002, filed Feb. 17, 2022, which claims priority to Hungarian Patent Application No. U2100167, filed Sep. 16, 2021. The entire disclosure of the aforementioned applications is incorporated herein by reference in its entirety for all purposes.

### FIELD OF THE INVENTION

The present invention relates generally to the field of weapon storage and administrative control systems, and more particularly to systems and methods for administering issuance, return, and inventory control of firearms by means of electronically controlled storage compartments, secure access mechanisms, and automated event logging.

### TERMINOLOGY AND CORRESPONDENCE TO PARENT DISCLOSURE

The parent U.S. application describes, inter alia, weapon locks with integrated electronics and reader units for RFID-based firearm identification, reader/control units for credential handling and local logging, and server/database components for event aggregation. The present application further describes those features at a compartment level: the lock (e.g., 01-3/02-3/03-3) can incorporate the parent's reader unit and associated electronics; an access terminal (04, 07-4) performs control-unit functions (credential intake, event creation, local buffering); and a supervisory server aggregates events in a database. In addition, the present disclosure introduces access barriers cooperating with the locks, state-sensor-triggered event generation, visual-indicator-assisted workflows (issuance/inventory), portable carts (07-1) with mounting rails (07-2) and rail-mounted compartments (07-3), and rapid issuance protocols, all interoperable with the parent's RFID-centric architecture.

Unless the context indicates otherwise, the term “storage compartment” as used herein encompasses an enclosure that includes a storage compartment housing, an access barrier that, when closed, prevents removal of the weapon, and a lock operable between locked and unlocked states, the lock being configured to cooperate with state sensor(s) to sense a lock state transition and/or barrier motion. In implementations consistent with the parent application, a weapon lock having integrated electronics and a reader unit may be arranged as part of, or integrated with, the lock of a storage compartment, and a cover, cowl, or shield associated with the lock may function as the access barrier for purposes of the present claims. Likewise, a reader or user-interface device described in the parent as a reader unit/control unit corresponds to the access terminal (04, 07-4) in the present embodiments, and the parent's server/database corresponds functionally to a supervisory server as described herein.

### BACKGROUND OF THE INVENTION

### Description of the Related Problems

In law enforcement and military environments, the issuance and return of firearms is traditionally a manual and paper-based process. Users typically sign weapons in and out of an armory by handwriting entries into a ledger or logbook. This process is time-consuming, prone to human error, and difficult to audit or analyze retrospectively.

For example, in a unit of sixty officers, the complete issuance of weapons may take over ninety minutes when performed manually. Furthermore, once weapons are issued, there is little or no reliable record of when a particular firearm has been removed, returned, or accessed, and data contained in handwritten logbooks cannot be processed efficiently for oversight or reporting purposes.

Additional security concerns arise because, in a conventional armory, an individual may access not only his or her own assigned firearm but also other weapons or accessories within the storage room. Components such as optical sights or magazines may be improperly removed, swapped, or tampered with, creating accountability and maintenance issues.

Accordingly, there exists a need for a digitally controlled, automated system that:
ensures only authorized users may access specific firearms,
automatically logs issuance and return events with time stamps and user identifiers,
secures each weapon individually to prevent tampering with components,
reduces the time required for mass issuance during alerts or emergencies, and
integrates with centralized databases to support administration, auditing, and logistics.

### DESCRIPTION OF THE PRIOR ART

Several attempts have been made to enhance firearm storage and tracking using electronic or biometric technologies. Representative examples are summarized below.

Crigger et al. (US 2008/0252414 A1) discloses a biometric access control system for tracking critical assets such as firearms. The system combines a kiosk-based identification station incorporating a biometric input reader with racks or lockers for storing weapons. The control system allows biometric authentication, RFID-based tracking of tagged weapons, and processor-driven release authorization. Although Crigger provides significant advances in access control, the system remains focused on biometric user identification coupled with rack-level storage, and does not address compartment-level control, modular scalability, or automated inventory reconciliation at the granularity required for modern armories.

Schmidt et al. (US 2017/0098148 A1) describes a radio frequency identification (RFID) capsule formed using nanoparticle inks and designed to be ingested or implanted for identifying a user. While Schmidt demonstrates novel RFID capsule fabrication and detection methods, its context is primarily biological identification of persons or animals rather than weapon storage or issuance. The teachings do not disclose a system for compartmentalized weapon storage or event-logging databases relevant to armory applications.

Bovet et al. (US 2016/0128798 A1) further illustrates RFID devices including capsules as known equivalents to RFID tags. Bovet focuses on RFID structures and protective encapsulation, but like Schmidt, it is concerned with general RFID device construction, not firearm-specific inventory administration or controlled storage.

Other prior art solutions exist in the domain of electronic gun safes, smart holsters, and biometric trigger locks. While these references address personal firearm security, they do not scale effectively to institutional armories managing dozens or hundreds of weapons.

In summary, while prior systems such as Crigger, Schmidt, and Bovet demonstrate elements of biometric authentication, RFID-based identification, and secure storage, none disclose or suggest a comprehensive automated weapon issuance and return system that integrates:
electronically controlled compartment locks with state sensors,
user-specific access terminals,
portable and wall-mounted modular architectures,
centralized server-based data aggregation, and
real-time monitoring and inventory functions.

The present invention addresses these shortcomings by providing a system and method that automates the entire lifecycle of firearm issuance, return, and inventory tracking, offering higher security, reduced administrative burden, and enhanced operational readiness.

### SUMMARY OF THE INVENTION

The present invention relates to a system for administering issuance and return of weapons and to a corresponding method. The invention ensures secure, compartment-level storage and automated event recording of weapon transactions, while supporting modular scalability and offline operation.

In one aspect, the invention provides a system comprising:
a plurality of storage compartments, each having a unique compartment identifier, an access barrier configured, when closed, to prevent removal of a weapon from the storage compartment, a lock operable between a locked state in which the access barrier is retained closed and an unlocked state in which the access barrier is permitted to open, and at least one state sensor configured to sense a state transition of the lock between the locked and unlocked states; and
an access terminal configured to receive a user identifier, to communicate with the storage compartments, and, in response to authorizing the user identifier, to (i) command a designated storage compartment to place its lock in the unlocked state, (ii) receive from that storage compartment an indication of the sensed lock state transition, and (iii) create and store an event record including at least the compartment identifier, the user identifier, and a time stamp corresponding to the time at which the lock state transition is sensed.

In certain embodiments, each storage compartment comprises a compartment controller and non-volatile memory configured to locally store time-stamped state-change records including the unique compartment identifier and to communicate the records to the access terminal. In some embodiments, the system further comprises a portable cart supporting a plurality of storage compartments, the cart including a mounting rail and electrical/data connectors by which the storage compartments are mechanically supported and receive power and data from the cart.

The access terminal may maintain, in a data store, a redundant copy of state-change records originating from the storage compartments, and may reconcile the redundant copy with locally stored records upon restoration of connectivity. Each storage compartment may further include a visual indicator comprising an RGB light source controllable by the access terminal to guide a user to a designated storage compartment during an issuance or a return and to indicate inventory-related status including identification of compartments expected to be empty during an inventory.

The system may operate on battery power to enable offline operation, and may further comprise a supervisory server configured to communicate via wired and/or wireless links with multiple access terminals, to aggregate and store event records, and to provide remote access to configuration and reporting functions. The supervisory server may automatically discover access terminals by reading terminal identifiers and registering newly connected access terminals.

The state sensor may detect at least one of: a contact or closure state of the access barrier or lock; a displacement or position change of a lock component; a proximity condition between cooperative lock elements; an optical interruption indicative of access-barrier movement; or a tamper condition relating to removal, opening, or displacement of a housing element. The access terminal itself may be embodied as a wall-mounted device or a mobile/handheld unit.

In another aspect, the invention provides a method of administering issuance and return of weapons, in a system as described above, the method comprising: receiving a user identifier at the access terminal; authorizing the user identifier; commanding, responsive to said authorizing, a designated storage compartment to place its lock in an unlocked state to allow opening of the access barrier; sensing, by the at least one state sensor of that storage compartment, a lock state transition indicative of removal or placement of a weapon; and generating and storing, by the access terminal, an event record including at least the compartment identifier, the user identifier, and a time stamp corresponding to the time at which the lock state transition is sensed.

Further method aspects include:
mounting a plurality of storage compartments on a portable cart, automatically discovering newly coupled compartments by reading their identifiers, and registering their capabilities;
controlling a visual indicator of at least one storage compartment to guide the user or indicate inventory-related status; and
operating offline, wherein the access terminal authorizes the user identifier, stores event records locally, and synchronizes the event records to a supervisory server upon restoration of connectivity.

Accordingly, the invention provides a comprehensive system and method enabling secure, automated, and auditable weapon issuance, return, and inventory management.

### BRIEF DESCRIPTION OF THE DRAWINGS

The drawings illustrate example embodiments of the disclosure. Like reference numerals denote like elements throughout the several views.

FIG. 1 shows a storage compartment configured for an MP5-type weapon, including a storage compartment housing (01-1), an access barrier (01-2), and a lock (01-3).

FIG. 2 shows a storage compartment configured for an M4-type weapon, including a storage compartment housing (02-1), an access barrier (02-2), and a lock (02-3).

FIG. 3 shows a storage compartment configured for a handgun, including a storage compartment housing (03-1), an access barrier (03-2), and a lock (03-3).

FIG. 4 shows an access terminal (04) including a display (04-1) and a credential reader (04-2) implemented as a combined RFID reader and PIN pad for receiving a user identifier.

FIG. 5 illustrates multiple storage compartments loaded with weapons oriented with the magazine facing outward.

FIG. 6 shows a wall-mounted arrangement of storage compartments with interspersed access terminals for local interaction and control.

FIG. 7 shows a mobile cart (07-1) with a mounting rail (07-2), a rail-mounted storage compartment (07-3), a cart-mounted access terminal (07-4), and a mechanical override key holder (07-5).

FIG. 8 shows a weapon room configured with multiple mobile carts as in FIG. 7. illustrating one possible layout.

FIG. 9 is a schematic of a wired topology including storage compartments (A), access terminals (B), a supervisory server (C), and an external network (D).

### DETAILED DESCRIPTION OF THE PREFERRED EMBODIMENTS

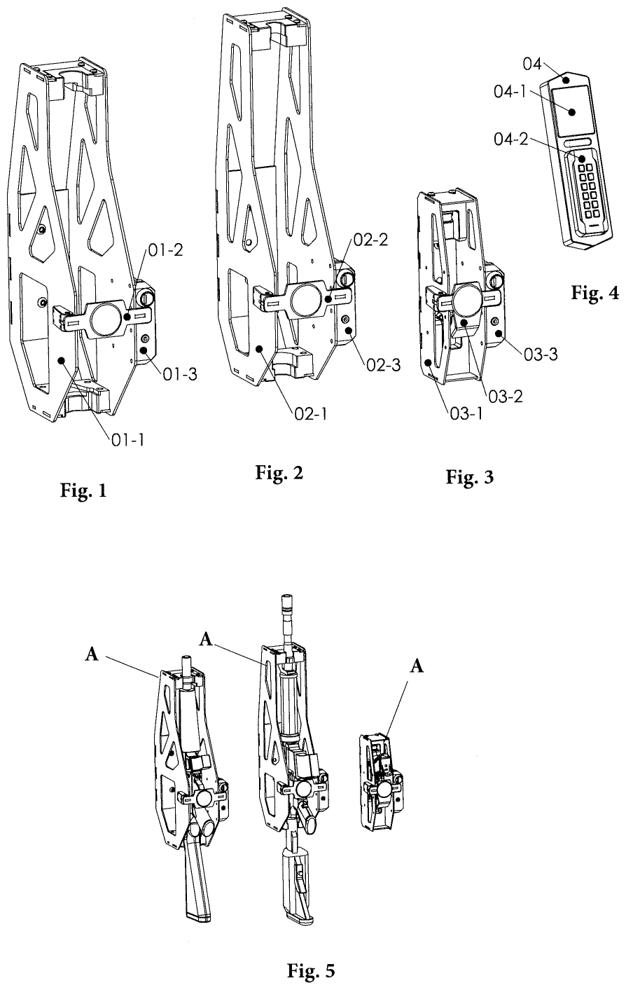

### Storage Compartments for Different Weapon Types (FIGS. 1-3).

In the embodiments shown in FIGS. 1-3, each weapon is secured within a storage compartment including a storage compartment housing (01-1; 02-1; 03-1), an access barrier (01-2; 02-2; 03-2) configured, when closed, to prevent removal of the weapon, and a lock (01-3; 02-3; 03-3) operable between locked and unlocked states. The access barrier 01-2, 02-2, 03-2 is mounted to the corresponding housing 01-1, 02-1, 03-1 for controlled movement; in representative forms the barrier is hinged along a longitudinal edge to pivot between open and closed positions, while in alternative forms the barrier is a sliding panel guided in linear rails fixed to the housing. The barrier may be formed from steel or aluminum sheet with internal reinforcement ribs, or from impact-resistant polycarbonate to permit visual confirmation of weapon presence while maintaining mechanical strength. In each case, the barrier's closed position overlaps landing surfaces of the housing so that, together with the lock 01-3, 02-3, 03-3, it resists prying and displacement.

The lock (01-3; 02-3; 03-3) is commanded by an access terminal (04) to transition between states. In one implementation the lock is a solenoid-actuated bolt engaging a hardened strike plate fixed to the housing 01-1, 02-1, 03-1. In another. the lock employs a motor-driven cam that rotates to release/retain the barrier 01-2, 02-2, 03-2; in yet another, a magnetically latched mechanism is used with electrical release. Preferably, the lock incorporates a mechanical override (e.g., a key cylinder integrated into the lock train) to enable manual release during complete power loss or emergency procedures. The lock further integrates a visual indicator, for example an RGB light source, that the access terminal 04 can drive to signal operational states (e.g., designation for issuance, confirmation of return, fault or tamper) and to support inventory workflows by highlighting selected compartments across an installation.

Each compartment includes at least one state sensor arranged to sense a state transition of the lock 01-3, 02-3, 03-3 between locked and unlocked states and/or to detect movement or closure of the access barrier 01-2, 02-2, 03-2. Suitable sensor realizations include: a contact/closure switch aligned with the barrier landing; a Hall-effect or reed sensor placed to register displacement of a moving lock element; a proximity sensor confirming cooperative alignment of lock components; and an optical interrupter oriented to detect barrier motion. A tamper switch may additionally be provided on the housing 01-1, 02-1, 03-1 to indicate removal, opening, or displacement of a panel. Sensor outputs are time-stamped and used to generate indications of lock state transitions that the access terminal 04 records as part of issuance and return transactions.

In FIG. 1, the housing 01-1 is dimensioned to stow a submachine-gun form factor (e.g., an MP5-type profile), the barrier 01-2 closes the housing opening, and the lock 01-3 secures the barrier in the locked state. FIG. 2 depicts a geometrically larger arrangement for an assault rifle (e.g., M4-type); the housing 02-1 accommodates the longer receiver and barrel profile, the barrier 02-2 covers the opening with similar kinematics, and the lock 02-3 provides equivalent securing and sensing functions. FIG. 3 shows a compact configuration for a handgun; the housing 03-1 defines a cavity sized for a pistol, the barrier 03-2 closes the cavity, and the lock 03-3 secures the barrier while integrating the aforementioned sensing and indicator features. Across these examples, internal guides and supports formed within the housings 01-1, 02-1, 03-1 stabilize the weapon in a repeatable position and, with the barrier 01-2, 02-2, 03-2 closed, deny access to ancillary components (e.g., optics, magazines), thereby inhibiting tampering during unrelated transactions.

In preferred forms, the compartment electronics include a compartment controller that interfaces with the lock 01-3, 02-3, 03-3, the state sensors, and the visual indicator, and communicates with the access terminal 04. The controller is coupled to non-volatile memory configured to locally store time-stamped state-change records including at least a unique compartment identifier and event timing; when connectivity is unavailable, records are buffered locally and reconciled with the access terminal 04 upon restoration of communications. During normal operation, a user approaches the access terminal 04, which presents a display (04-1) and a credential reader (04-2) (e.g., combined RFID reader and PIN pad) for receiving a user identifier. Upon authorization, the terminal 04 designates a specific compartment by its identifier, commands the corresponding lock (01-3; 02-3:03-3) to the unlocked state, and drives the integrated indicator to a conspicuous pattern to guide the user directly to the correct location. Opening the barrier (01-2; 02-2; 03-2) and removing the weapon causes the state sensor to report the sensed lock state transition, whereupon the terminal 04 creates and stores an event record including at least the compartment identifier, the user identifier, and a time stamp. On return, closure of the barrier and transition of the lock back to the locked state are likewise sensed and recorded.

The housings (01-1; 02-1; 03-1) can be fabricated as welded steel enclosures for maximum tamper resistance, as bent-sheet aluminum structures to reduce weight, or as hybrid composite constructions (e.g., aluminum frame with polycarbonate barrier 01-2, 02-2, 03-2) to combine stiffness with visibility. The barriers 01-2, 02-2, 03-2 may incorporate gasketed interfaces to reduce rattling and to protect internal electronics from dust and moisture in field conditions. Locking mechanisms (01-3; 02-3; 03-3) may further include position encoders to provide high-confidence verification of latch engagement, and the visual indicator can be realized as a single multi-die RGB LED or a segmented LED bar to convey distinct operational codes (steady, blink, color cycles) visible from a distance.

Because each compartment is identified by a unique compartment identifier, relocation of a compartment—e.g., from a wall-mounted array to a cart-mounted array described elsewhere—can be automatically recognized by the access terminal 04 and higher-level control, preserving continuity of administrative records without manual re-commissioning. In certain implementations, the compartments and the access terminal 04 remain operable on battery power, enabling offline operation in which events are stored locally and synchronized when connectivity to supervisory infrastructure is restored.

### Access Terminal and Wall-Mounted Configurations (FIGS. 4-6).

Referring to FIG. 4, an access terminal 04 is illustrated. The access terminal 04 functions as the primary user interface for administering issuance and return of weapons. The access terminal 04 includes a display 04-1, which may be a liquid crystal panel, an organic light-emitting diode panel, or a touchscreen, and is configured to present operational prompts, status information, and confirmation of transactions. The access terminal 04 further comprises a credential reader 04-2, shown here as a combined RFID reader and PIN pad. In alternative embodiments, the credential reader 04-2 may be configured as a biometric reader such as a fingerprint scanner, facial recognition unit, or iris scanner. In each case, the credential reader 04-2 is operable to receive a user identifier and to communicate it to the control circuit of the access terminal 04 for authorization.

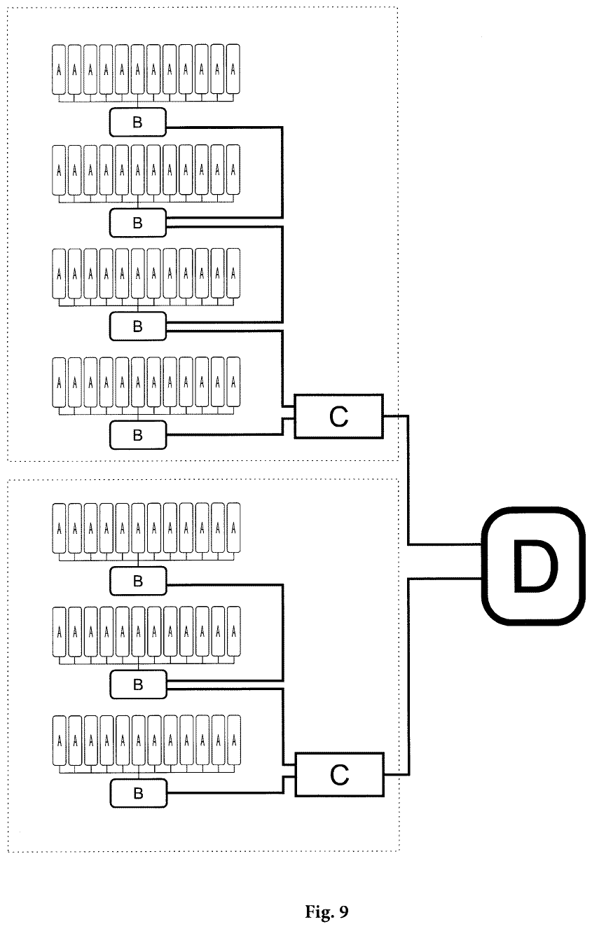

The access terminal 04 contains an embedded microcontroller and local non-volatile memory for storing event records, user lists, and configuration data. In preferred embodiments, the memory maintains a redundant copy of state-change records received from the storage compartments A, enabling reconciliation with records buffered within the compartments themselves. This design ensures that, in the event of communication loss, no issuance or return event is lost. When connectivity is restored, the access terminal 04 automatically synchronizes its event records with higher-level systems such as a supervisory server C (described further with reference to FIG. 9).

As shown in FIG. 5, a plurality of storage compartments A are illustrated, each loaded with a weapon oriented with the magazine facing outward. Each storage compartment housing (01-1; 02-1; 03-1) is covered by its respective access barrier (01-2; 02-2; 03-2) and secured by a corresponding lock (01-3; 02-3; 03-3). The state sensors within each lock detect transitions between locked and unlocked states, as well as movement of the barriers, and transmit signals to the access terminal 04. The terminal 04, upon receipt of such signals, generates electronic event records including the compartment identifier, the user identifier, and a time stamp. Because the records are tied to sensed physical transitions rather than to software commands alone, the resulting audit trail is more reliable for administrative and evidentiary purposes.

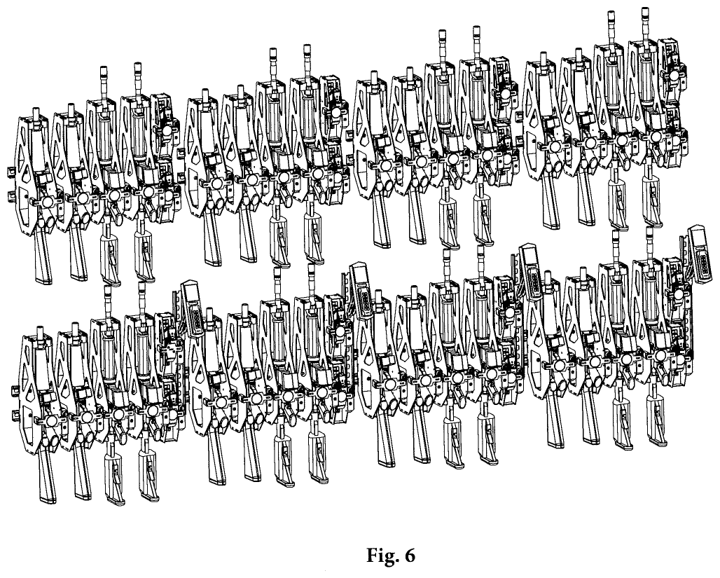

FIG. 6 illustrates a wall-mounted installation in which a plurality of storage compartments A are arranged along a mounting surface. Between groups of compartments A, one or more access terminals 04 are mounted, each terminal controlling and communicating with its associated compartments. In such an arrangement, users can approach any of several terminals to present their user identifiers. Upon successful authorization, the designated compartment is commanded to unlock, and its integrated visual indicator is driven to a conspicuous state, guiding the user directly to the correct compartment. This wall-mounted architecture is particularly suitable for permanent armory installations, as it enables dense packing of storage compartments A while maintaining multiple distributed access points, thereby reducing bottlenecks and accelerating the issuance process.

The access terminal 04 further supports operational modes that increase efficiency. In a rapid issuance mode, all compartments under control of the terminal 04 may be unlocked simultaneously, significantly reducing weapon distribution time during alerts. In an inventory mode, the access terminal 04 drives the visual indicators of compartments identified as empty, for example by flashing their RGB lights, enabling an administrator to complete a full inventory with a rapid visual scan.

In all configurations shown in FIGS. 4-6, the access terminal 04 and the storage compartments A are operable on battery power, allowing continued offline operation when wired power or network connections are unavailable. In such conditions, the terminal 04 continues to authorize user identifiers, to unlock designated compartments, and to log events locally. Once connectivity to a higher-level system such as a supervisory server is restored, the terminal 04 automatically synchronizes its buffered records, ensuring consistency of the global database.

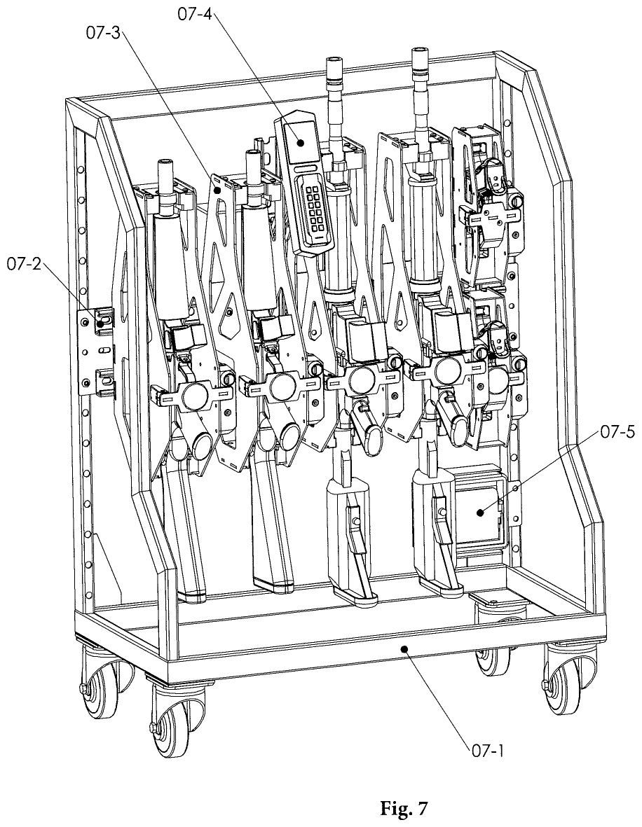

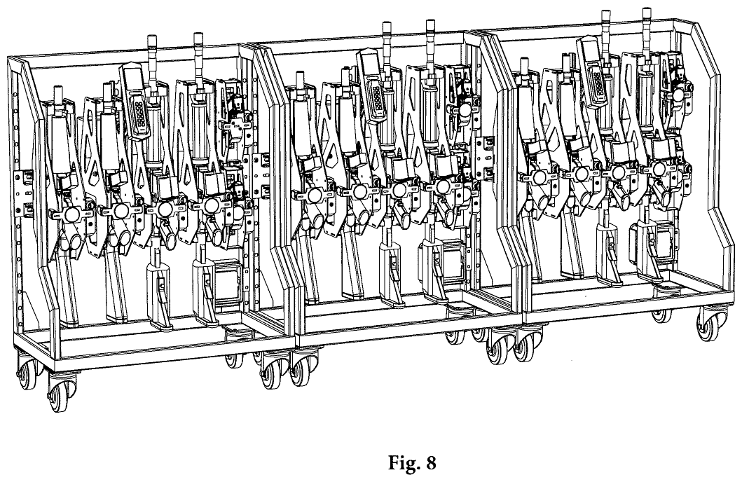

### Mobile Cart-Based Configurations and System Topology (FIGS. 7-9).

Referring now to FIG. 7, a mobile cart 07-1 is illustrated. The cart 07-1 is constructed as a wheeled frame that supports multiple weapon storage compartments. Affixed to the cart 07-1 is a mounting rail 07-2, onto which a plurality of rail-mounted storage compartments 07-3 are secured. Each storage compartment 07-3 corresponds structurally to the embodiments described with reference to FIGS. 1-3, including a storage compartment housing, an access barrier, and a lock with integrated sensors and a visual indicator. The mounting rail 07-2 provides both mechanical support and electrical/data connectivity, supplying power and communication lines to the attached storage compartments 07-3.

The cart 07-1 further incorporates an access terminal 07-4, which in preferred embodiments is identical in function to the access terminal 04 described previously, but is mounted integrally on the cart. The access terminal 07-4 includes a display and credential reader, enabling users to present identifiers directly at the cart. Each cart 07-1 also includes a mechanical override key holder 07-5, which securely stores manual override keys for emergency access to the compartments in case of catastrophic system failure or prolonged power outage.

This mobile architecture enables an entire armory to be relocated in a matter of minutes. Multiple carts 07-1 can be disconnected from each other, rolled into a transport container, and reconnected at a new site. Because each storage compartment has a unique identifier and each access terminal 07-4 has its own digital identifier, the system automatically recognizes reconfigured layouts and updates connectivity without manual re-commissioning. Such capability is especially advantageous for forward-deployed units, field operations, or temporary installations, where rapid redeployment of secure weapon storage is essential.

FIG. 8 illustrates an exemplary weapon room layout equipped with multiple mobile carts 07-1. The carts are arranged in parallel rows, each cart supporting its series of rail-mounted compartments 07-3 and including its access terminal 07-4. In such configurations, dozens or even hundreds of weapons can be administered in a compact space. Because each cart 07-1 includes both control and storage elements, multiple users can be processed simultaneously, thereby minimizing bottlenecks. This arrangement significantly accelerates issuance: for example, in a sixty-person unit, full issuance that previously required over ninety minutes using manual logbooks can be reduced to approximately ten minutes under normal conditions, and to under five minutes in alert conditions.

Turning to FIG. 9, a schematic of the overall system topology is presented. The diagram shows multiple storage compartments A, each associated with its respective identifier and event-logging capability. Groups of storage compartments A are managed by access terminals B, which may be wall-mounted terminals 04, cart-mounted terminals 07-4, or handheld/mobile variants. The access terminals B communicate with a supervisory server C, which is configured to aggregate and store event records from the access terminals, to maintain a master database of users and weapons, and to provide administrative and reporting functions. In preferred embodiments, the supervisory server C is implemented as an industrial computer with redundant storage, capable of automatically discovering newly connected access terminals by reading their identifiers and registering their capabilities.

The supervisory server C is further connected to an external network D, enabling remote access to monitoring and configuration software. Through this connectivity, authorized administrators can perform real-time monitoring of weapon status, run automated reports, or reconfigure access rights from remote command centers. The server C may also support secure communications via wired Ethernet, fiber links, or wireless protocols, depending on installation requirements.

Importantly, the entire system—comprising storage compartments A, access terminals B, supervisory server C, and external network D—is designed to continue functioning in offline mode when connectivity is interrupted. Both the storage compartments and the access terminals are operable on battery power for extended durations, buffering event records locally. Upon restoration of network connectivity, all buffered records are automatically synchronized with the supervisory server C, ensuring a complete and continuous audit trail across deployments.

Having provided a detailed description of the hardware components associated with the storage compartments A—including, by way of example, the storage compartment housings 01-1, 02-1, 03-1, the corresponding access barriers 01-2, 02-2, 03-2, and locks 01-3, 02-3, 03-3—as well as the access terminals 04 and 07-4, and the mobile cart 07-1, an explanation will now be made of the associated operating method that enables coordinated administration of issuance and return across the previously described components. The supervisory layer will be discussed later with reference to FIG. 9.

In operation, the method begins by receiving, at an access terminal 04 or 07-4, a user identifier via a credential reader 04-2 (e.g., RFID card and/or PIN entry) and presenting prompts and status on a display 04-1. The access terminal 04 (or cart-mounted access terminal 07-4) authorizes the user identifier against locally stored data or, when available, in communication with a supervisory layer described with reference to FIG. 9. Upon successful authorization, the terminal designates a particular storage compartment A based on assignment policy and commands the corresponding lock (e.g., lock 01-3, 02-3, or 03-3, depending on weapon type) to transition to the unlocked state, thereby permitting opening of the associated access barrier 01-2, 02-2, 03-2.

When the user opens the access barrier (01-2/02-2/03-2) and removes the weapon, state sensors integrated with the relevant lock (01-3/02-3/03-3) sense a lock state transition and, where provided, barrier motion. The access terminal 04 (or 07-4) creates and stores an event record including at least the compartment identifier, the user identifier, and a time stamp corresponding to the sensed transition. In preferred embodiments, this record is stored locally at the terminal and also propagated, when connectivity is available, to a supervisory layer (see FIG. 9) to ensure redundancy and centralized auditing.

For return, the same sequence is executed in reverse. The user again presents credentials at the access terminal 04 (or 07-4); the terminal designates the assigned storage compartment A, unlocks the relevant lock 01-3/02-3/03-3, and upon reinsertion of the weapon and closure of the access barrier 01-2/02-2/03-2, the sensors signal the transition back to the locked state. The event is time-stamped and recorded in the same manner, so that a complete, sensor-verified audit trail is maintained.

In a further embodiment, when multiple storage compartments A are mounted on a portable cart 07-1, the access terminal 07-4 on that cart automatically discovers the attached rail-mounted storage compartments 07-3 over the mounting rail 07-2 by reading their unique compartment identifiers and registers corresponding capabilities. This allows rapid reconfiguration of cart populations without manual re-commissioning.

In another embodiment, the access terminal (04 or 07-4) controls a visual indicator integrated with the locks (e.g., within lock 01-3/02-3/03-3) to assist with inventory. In an inventory mode, compartments expected to be empty are driven to a conspicuous pattern (e.g., a flashing RGB state), enabling an administrator to perform a rapid visual sweep of all storage compartments A to verify status.

In yet another embodiment, the system supports offline operation on battery power. During a connectivity outage, access terminals 04 and 07-4 continue to authorize user identifiers based on local data and log all issuance/return events locally; storage compartments A likewise buffer time-stamped state-change records at compartment level. Upon restoration of network connectivity to a supervisory layer (described with reference to FIG. 9), all buffered records are synchronized, ensuring the central database remains complete.

Through these coordinated steps—credential capture at access terminals 04/07-4, controlled unlocking and barrier operation at the compartment level (01-2/01-3:02-2/02-3; 03-2/03-3), sensor-verified event generation tied to sensed transitions, and redundancy via later synchronization—the method provides a robust, auditable workflow for administering issuance and return across both fixed wall-mounted arrays and mobile cart 07-1 deployments.

In yet another operational mode, the system supports a rapid issuance protocol designed for emergency situations. In this embodiment, a user with elevated authorization rights may, by presenting their PIN code and/or credential at an access terminal 04 or 07-4, command the simultaneous unlocking of all storage compartments A associated with that access terminal. This enables a complete unit of personnel to retrieve weapons in a matter of minutes, significantly reducing mobilization time compared with manual issuance procedures.

In an extended configuration, when the command is issued through a supervisory layer (see FIG. 9), the authorized user may initiate unlocking of all storage compartments A across an entire facility or object, rather than just those associated with a single access terminal 04. This feature allows for system-wide rapid distribution of weapons in emergencies, while all unlocking events remain time-stamped, user-attributed, and logged both locally and at the supervisory level, thereby maintaining a complete audit trail even under accelerated issuance conditions.

In a further method variant, the lock of the designated storage compartment A includes a reader unit configured to read an RFID capsule associated with the stored weapon. During issuance and return, the access terminal (04 or 07-4) associates the user identifier with the weapon identifier read by the lock's reader unit and creates an event record that includes both identifiers and a time stamp tied to the sensed lock-state transition. Records are stored locally and, when available, synchronized to a supervisory layer, thereby preserving the audit trail in configurations that employ RFID-based weapon identification consistent with the parent disclosure while maintaining the present claims' compartment-level structure.

### ALTERNATIVE EMBODIMENTS

In an alternative embodiment consistent with the present claims, each storage compartment A is configured such that its lock (e.g., 01-3/02-3/03-3) incorporates electronics of the type described in the parent application, including a reader unit operable to read an RFID capsule associated with the weapon. A cover or cowl that forms part of the compartment functions as the access barrier (e.g., 01-2/02-2/03-2), cooperating with the lock to prevent removal of the weapon when closed. The lock further cooperates with state sensors to sense a lock state transition and/or barrier displacement, and a visual indicator integrated with the lock provides user guidance and status information. A user presents credentials at an access terminal (04 or 07-4)—functionally corresponding to the parent's control unit—which authorizes the user, commands the designated compartment to unlock, and creates and stores an event record including at least the compartment identifier, user identifier, and a time stamp corresponding to the sensed transition. Event records are buffered locally and, when connectivity is available, synchronized to a supervisory server for aggregation and reporting. Thus, the parent's RFID-centric identification and logging scheme is implemented within the present compartment-level architecture without departing from the claim-required features (access barrier, lock, and state sensor).

1. A system for administering issuance and return of weapons, comprising: a plurality of storage compartments, each having a unique compartment identifier, an access barrier configured, when closed, to prevent removal of a weapon from the storage compartment, a lock operable between a locked state in which the access barrier is retained closed and an unlocked state in which the access barrier is permitted to open, and at least one state sensor configured to sense a state transition of the lock between the locked and unlocked states; and an access terminal configured to receive a user identifier, to communicate with the storage compartments, and, in response to authorizing the user identifier, to (i) command a storage compartment designated based on the user identifier to place its lock in the unlocked state, (ii) receive from that storage compartment an indication of the sensed lock state transition, and (iii) create and store an event record including at least the compartment identifier, the user identifier, and a time stamp corresponding to the time at which the lock state transition is sensed.

2. The system of claim 1, wherein each storage compartment comprises a compartment controller and non-volatile memory configured to locally store time-stamped state-change records including the unique compartment identifier and to communicate the records to the access terminal.

3. The system of claim 1, further comprising a portable cart supporting a plurality of the storage compartments, the cart including a mounting rail and electrical/data connectors by which the storage compartments are mechanically supported and receive power and data from the cart.

4. The system of claim 1, wherein the access terminal maintains, in a data store, a redundant copy of state-change records originating from the storage compartments and is configured to reconcile the redundant copy with locally stored records upon restoration of connectivity.

5. The system of claim 1, wherein each storage compartment includes a visual indicator comprising an RGB light source controllable by the access terminal to guide a user to a designated storage compartment during an issuance or a return and to indicate inventory-related status including identification of compartments expected to be empty during an inventory.

6. The system of claim 1, wherein the access terminal and the storage compartments are operable on battery power to enable offline operation.

7. The system of claim 1, further comprising a supervisory server configured to communicate via wired and/or wireless links with a plurality of access terminals, to aggregate and store event records received from the access terminals, and to provide remote access to configuration and reporting functions.

8. The system of claim 7, wherein the supervisory server is configured to automatically discover access terminals by reading terminal identifiers and to register newly connected access terminals.

9. The system of claim 1, wherein the state sensor is configured to detect at least one of: (i) a contact/closure state of the access barrier or the lock; (ii) a displacement or position change of a lock component; (iii) a proximity condition between cooperative lock elements; (iv) an optical interruption or variation indicative of access-barrier movement; or (v) a tamper condition relating to removal, opening, or displacement of a housing element.

10. The system of claim 1, wherein the access terminal is a wall-mounted spot device or a mobile/handheld unit.

11. The system of claim 1, wherein the lock comprises a reader unit configured to read an RFID identifier of the weapon and the access terminal is configured to store, in the event record, an association between the user identifier and the RFID identifier.

12. A method of administering issuance and return of weapons, in a system comprising a plurality of storage compartments each having a unique compartment identifier, an access barrier, a lock operable between locked and unlocked states, and at least one state sensor, and an access terminal in communication with the storage compartments, the method comprising:
receiving, at the access terminal, a user identifier;
authorizing the user identifier;
commanding, responsive to said authorizing, the storage compartment designated based on the user identifier to place its lock in an unlocked state to allow opening of the access barrier;
sensing, by the at least one state sensor of that storage compartment, a lock state transition indicative of removal or placement of a weapon; and
generating and storing, by the access terminal, an event record including at least the compartment identifier, the user identifier, and a time stamp corresponding to the time at which the lock state transition is sensed.

13. The method of claim 12, further comprising mounting a plurality of storage compartments on a portable cart providing mechanical support and power/data connectors, and automatically discovering, by the access terminal, storage compartments newly coupled by reading respective unique compartment identifiers and registering corresponding capabilities.

14. The method of claim 12, further comprising controlling, by the access terminal, a visual indicator of at least one storage compartment to guide the user to a designated storage compartment during an issuance or a return and to indicate inventory-related status including identification of compartments expected to be empty during an inventory.

15. The method of claim 12, further comprising operating offline by authorizing the user identifier at the access terminal, storing event records locally, and synchronizing the event records to a supervisory server upon restoration of network connectivity.

16. The method of claim 12, further comprising reading, during issuance or return, an RFID identifier of the weapon via a reader unit within the lock, and storing in the event record an association between the user identifier and the RFID identifier.
